(19) United States
(12) Patent Application Publication
(10) Pub. No.: US 2009/0038489 A1
(43) Pub. Date: Feb. 12, 2009

(54) Method of Screen Printing With Semi-Continuous Replenishment

(76) Inventor: Andrew J. Edelbrock, Granger, IN (US)

Correspondence Address: NIXON PEABODY LLP, 161 N. CLARK STREET, 48TH FLOOR, CHICAGO, IL, 60601, US

(21) Appl. No.: 12/084,439

(22) PCT Filed: Nov. 27, 2006
(86) PCT No.: PCT/US2006/045420

§ 371 Date: May 1, 2008

Related U.S. Application Data
(60) Provisional application No. 60/740,348, filed on Nov. 29, 2005.

(51) Int. Cl. B41M 1/12

(52) U.S. Cl. 101/129

(57) ABSTRACT

A method of screen printing on a substrate comprises providing a screen including a first portion with an emulsion and a second portion formed without an emulsion. An ink solution is supplied on the screen. The ink solution comprises a solid and a liquid. The ink solution includes an enzyme to assist in determining an analyte concentration of a fluid sample. The ink solution contacts the substrate via the second portion of the screen. The ink solution is mechanically replenished in semi-continuous intervals from an ink-solution reservoir.

### FIELD OF THE INVENTION

The present invention generally relates to a method of printing. More specifically, the present invention generally relates to a method of printing (e.g., screen printing) on a substrate using a mechanical semi-continuous replenishment.

### BACKGROUND OF THE INVENTION

The quantitative determination of analytes in body fluids is of great importance in the diagnoses and maintenance of certain physiological abnormalities. For example, lactate, cholesterol and bilirubin should be monitored in certain individuals. In particular, it is important that diabetic individuals frequently check the glucose level in their body fluids to regulate the glucose intake in their diets. The results of such tests can be used to determine what, if any, insulin or other medication needs to be administered. In one type of blood-glucose testing system, sensors are used to test a sample of blood.

A test sensor contains biosensing or reagent material that reacts with blood glucose. One method of applying the reagent or enzyme to a substrate that forms the test sensor is by screen printing. Screen printing uses a screen that has portions with and without an impervious emulsion. The desired image is formed from the portion without the impervious emulsion. There are different types of screen-printing techniques such as an alternate print technique, a print-print technique, a print-flood technique and a flood-print technique.

In the alternate print technique, an ink solution is pushed from one end of the screen to the other end of the screen. The ink solution is pushed across the screen using, for example, a squeegee blade. The squeegee blade also pushes the ink solution through the open areas of the emulsion and onto the substrate. In the alternate print technique, every stroke across the screen produces a printed substrate. Stencil printing is similar to alternate screen printing but uses a stencil or mask to define the print area.

The print-print technique has a first and second print that occurs on the same substrate. The first print proceeds in the forward direction and the second print proceeds in the reverse direction.

In the print-flood technique, a print cycle is followed by a flood cycle where the screen is uniformly covered with an ink solution by a flood bar. Ink solution is added relatively infrequently and in large aliquots, enough for scores of printings without replenishment. This print-flood technique assists in inhibiting the ink solution from drying out, but results in the screen always being covered with a wet ink solution layer. The flood-print technique includes a flood cycle followed by a print cycle. One disadvantage of the flood-print technique is the tendency of high volatile, ink solutions to dry out since the screen is not always being covered with a wet ink-solution layer.

Each of the above screen-printing and stencil-printing techniques is an open process that allows the ink solution to be exposed to ambient conditions for long periods of time. Consequently, screen-printing and stencil-printing techniques use ink with relatively high boiling, less volatile liquids so that the ink composition remains unchanged between ink additions (i.e., does not evaporate). Screen-printing/stencil-printing techniques with relatively high boiling, less volatile liquids will typically not work well in applications involving enzymes that determine analyte concentrations because these enzymes are not typically stable in such liquids. If the enzymes are not stable, the enzymes may not work for their intended purpose of determining analyte concentrations. For example, the enzyme glucose oxidase, which may be used in determining the analyte concentration of glucose, is typically stable in water and may rapidly inactivate in most organic liquids. Thus, to achieve the desired reactivity of glucose oxidase, the liquid typically is aqueous.

To reduce the effect of evaporation of an aqueous liquid, relative high humidity atmospheres must be used in the screen-printing techniques. Even with such high humidity atmospheres, aqueous liquids are still susceptible to evaporation. Eventually, evaporation of the low volatile components of the ink solution leads to an undesirable concentration and viscosity of the ink components. Additionally, when ink solution with certain enzymes and/or mediators (e.g., glucose oxidase and potassium ferricyanide) is pushed back and forth over the screen, a small amount of an electrochemically oxidizable species over time is formed due to ambient conditions/materials that the enzyme comes in contact with. This amount of the electrochemically oxidizable species increases over time as the aliquot of ink remains on the screen. While not being bound by theory, the electrochemically oxidizable species of glucose oxidase with potassium ferricyanide is believed to be potassium ferrocyanide. Having an electrochemically oxidizable species is undesirable because it leads to an increasing positive bias to the measured glucose of the fluid.

Therefore, it would be desirable to perform a method of printing that overcomes such problems.

### SUMMARY OF THE INVENTION

According to one method of screen printing on a substrate, a screen is provided that includes a first portion with an emulsion and a second portion formed without an emulsion. An ink solution is supplied on the screen. The ink solution comprises a solid and a liquid. The ink solution includes an enzyme to assist in determining an analyte concentration of a fluid sample. The ink solution is contacted onto the substrate via the second portion of the screen. The ink solution is mechanically replenished in semi-continuous intervals from an ink-solution reservoir.

According to another method of screen printing on a substrate, a screen is provided that includes a first portion with an emulsion and a second portion formed without an emulsion. An ink-reservoir system is provided that includes a plunger, a control valve and an ink-solution reservoir. The ink-reservoir system maintains a generally constant pressure. An ink solution is supplied on the screen. The ink solution comprises a solid and a liquid. The ink solution includes an enzyme to assist in determining an analyte concentration of a fluid sample. The ink solution contacts the substrate via the second portion of the screen. The ink solution is mechanically replenished in semi-continuous intervals from the ink-solution reservoir.

According to a further method of screen printing on a substrate, a screen is provided that includes a first portion with an emulsion and a second portion formed without an emulsion. An ink-reservoir system is provided that includes a plunger, a controlled displacement mechanism adapted to move a known distance, and an ink-solution reservoir. The movement of the controlled displacement mechanism results in a known amount of ink solution being displaced from the ink-reservoir system. An ink solution is supplied on the screen. The ink solution comprises a solid and a liquid. The ink solution includes an enzyme to assist in determining an analyte concentration of a fluid sample. The ink solution is contacted onto the substrate via the second portion of the screen. The ink solution is mechanically replenished in semi-continuous intervals from the ink-solution reservoir.

According to one method of stencil printing on a substrate, a stencil is provided. An ink solution is supplied on the stencil. The ink solution comprises a solid and a liquid. The ink solution includes an enzyme to assist in determining an analyte concentration of a fluid sample. The ink solution contacts onto the substrate. The ink solution mechanically replenishes in semi-continuous intervals from an ink-solution reservoir.

According to another method of stencil printing on a substrate, a stencil is provided. An ink-reservoir system is provided that includes a plunger and a control valve. The ink-reservoir system maintains a generally constant pressure. An ink solution is supplied on the stencil from the ink-reservoir system. The ink solution comprises a solid and a liquid. The ink solution includes an enzyme to assist in determining an analyte concentration of a fluid sample. The ink solution is contacted onto the substrate. The ink solution is mechanically replenished in semi-continuous intervals from an ink-solution reservoir.

According to a further method of stencil printing on a substrate, a stencil is provided. An ink-reservoir system is provided that includes a plunger and a controlled displacement mechanism adapted to move a known distance. The movement of the controlled displacement mechanism results in a known amount of ink solution being displaced from the ink-reservoir system. An ink solution is supplied on the stencil from the ink-reservoir system. The ink solution comprises a solid and a liquid. The ink solution includes an enzyme to assist in determining an analyte concentration of a fluid sample. The ink solution contacts onto the substrate. The ink solution mechanically replenishes in semi-continuous intervals from an ink-solution reservoir.

According to yet another method of screen printing on a substrate, a screen is provided that includes a first portion with an emulsion and a second portion formed without an emulsion. An adhesive solution is applied on the screen. The adhesive solution comprises a solid and a liquid. The adhesive solution is adapted to bind the substrate to a second surface. The adhesive solution is contacted onto the substrate via the second portion of the screen. The adhesive solution is mechanically replenished in semi-continuous intervals from an adhesive-solution reservoir.

According to yet another method of stencil printing on a substrate, a stencil is provided. An adhesive solution is supplied on the stencil. The adhesive solution comprises a solid and a liquid. The adhesive solution is adapted to bind the substrate to a second surface. The adhesive solution is applied onto the substrate. The adhesive solution is mechanically replenished in semi-continuous intervals from an adhesive-solution reservoir.

### BRIEF DESCRIPTION OF THE DRAWINGS

FIG. 1a is a process schematic of one method of replenishing the ink solution using a screen according to one embodiment.

FIG. 1b is a process schematic of one method of replenishing the ink solution using a stencil according to one embodiment.

FIG. 2a is a top view of a screen according to one embodiment that may be used in a screen-printing.

FIG. 2b is an enlarged view of generally circular area of FIG. 2b in FIG. 2a.

FIG. 2c is a top view of a stencil according to one embodiment that may be used in stencil-printing process.

FIG. 2d is an enlarged view of generally circular area of FIG. 2d in FIG. 2c.

FIG. 2e is a top view of a stencil according to another embodiment that may be used in stencil-printing process.

FIG. 2f is an enlarged view of generally circular area of FIG. 2f in FIG. 2e.

FIG. 2g is an enlarged view of generally circular area of FIG. 2g in FIG. 2e.

FIG. 3a is a side view of a cartridge under a generally constant pressure according to one embodiment with a controllable valve for ink dispensing.

FIG. 3b is a side view of a cartridge with controlled displacement using a plunger according to one embodiment.

### DETAILED DESCRIPTION OF ILLUSTRATED EMBODIMENTS

The present invention is directed to a method of printing on a substrate by semi-continuously replenishing the ink solution. Examples of printing methods include screen printing and stencil printing. By semi-continuously replenishing the ink solution, the present invention allows improved control of the viscosity of the ink solution, reduced waste/consumption of the ink solution and in certain applications, the potential reduction of undesirable electrochemically species.

In one embodiment, a substrate is used in forming a test sensor. The test sensor is adapted to receive a fluid sample and to be analyzed using an instrument or meter. The test sensor is used to determine concentrations of analytes. Analytes that may be measured include glucose, lipid profiles (e.g., cholesterol, triglycerides, LDL and HDL), microalbumin, hemoglobin A_{1C}, fructose, lactate, or bilirubin. It is contemplated that other analyte concentrations may be determined. The analytes may be in, for example, a whole blood sample, a blood serum sample, a blood plasma sample, other body fluids like ISF (interstitial fluid) and urine, and non-body fluids. As used within this application, the term “concentration” refers to an analyte concentration, activity (e.g., enzymes and electrolytes), titers (e.g., antibodies), or any other measure concentration used to measure the desired analyte.

The substrates may be made of a variety of materials. For example, the substrates may be made of polymeric materials, ceramic materials, and green tape. Some non-limiting examples of polymeric materials include polyethylene terephthalate (PET) and polycarbonate.

In one embodiment, the present invention improves test sensor performance by having a more consistent ink-solution composition and reducing undesirable electrochemically species when using an enzyme such as, for example, glucose oxidase. While not being bound by theory, in an embodiment using the enzyme glucose oxidase and the mediator potassium ferricyanide, it is believed that the production of potassium ferrocyanide is reduced. By reducing the amount of potassium ferrocyanide generated, a test sensor will produce improved results by reducing the bias when measuring low glucose concentration of a fluid.

In another application, the methods of screen printing and stencil printing may be used to print spacers onto a substrate that is to be used in forming the test sensors. Additionally, the methods of screen printing and stencil printing may be used to print adhesives for the test sensors. The ink solution would include adhesive materials, such as those known in the art, that would be applied to a substrate to be used in forming the test sensor. For example, the ink solution may be a resin or binder system that is adapted to join the substrate to a second layer. In this embodiment, the printed adhesive may be later heated to join the substrate and a second layer.

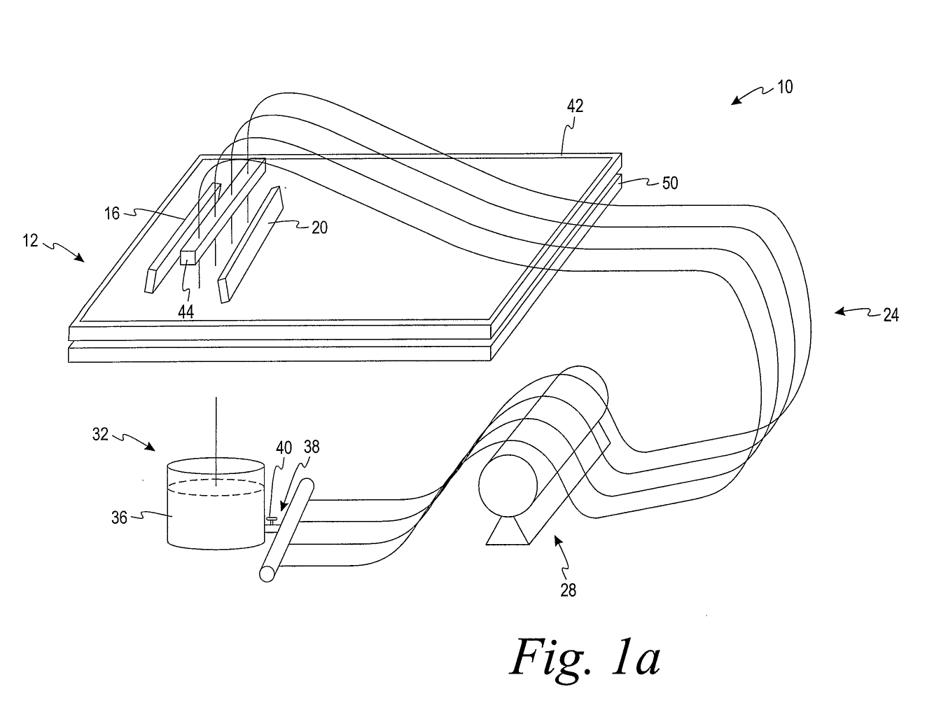

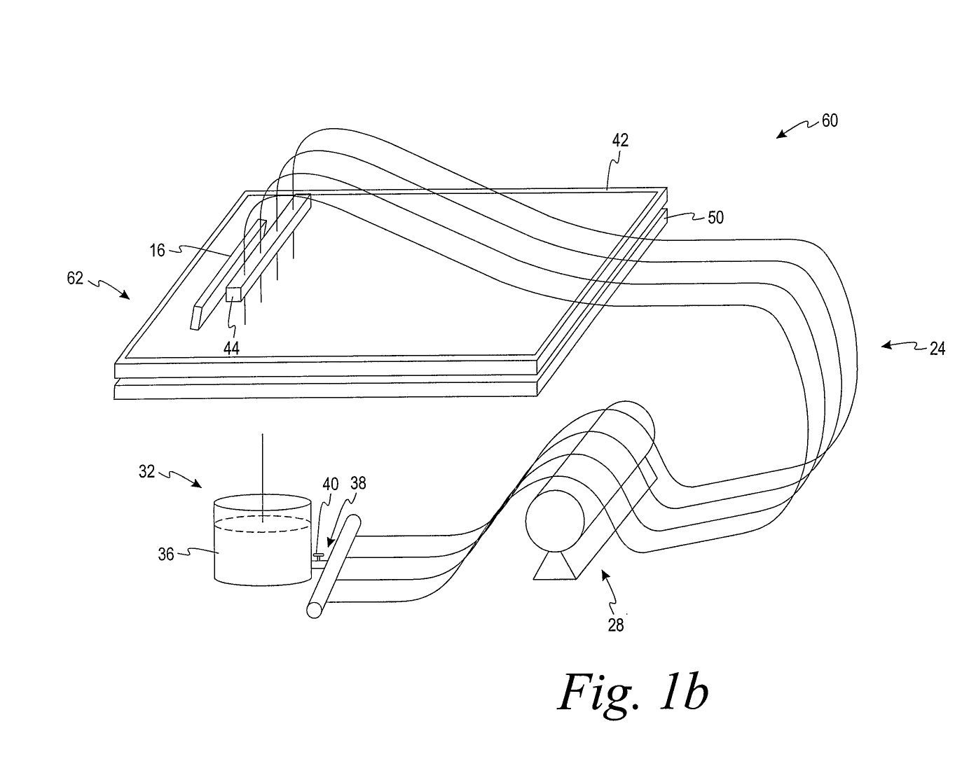

Referring to FIG. 1a, a schematic for an ink-replenishing screen-printing system is shown. Ink-replenishing system 10 of FIG. 1a includes a screen 12, a squeegee 16, a floodbar 20, a plurality of tubes 24, a pump 28 and an ink-solution reservoir or vessel 32. The screen 12 of FIG. 1a is shown as being enclosed by a frame 42 to provide additionally support thereto. The ink-solution vessel 32 contains an ink solution 36 that is eventually transported to the screen 12. The ink solution 36 comprises a solid portion and a liquid portion. To reduce or eliminate the removal and subsequent disposal of unused ink solution, the replenished ink solution is desirably added at the rate (amount and frequency) that it is consumed. This assists in maintaining a consistent ink-solution composition and in some applications assists in reducing a positive bias to the measured analyte of the fluid caused by an electrochemically oxidizable species.

The vessel 32 may be pressurized to assist the ink solution 36 from exiting an opening 38 and reaching the screen 12. The pressurized vessel may also include a valve 40 to control the amount and frequency of the ink solution exiting the vessel. It is contemplated that the vessel may not be pressurized. In such embodiments, the ink vessel may include a pump to assist in transporting the ink solution from the vessel to the screen.

Specifically, as shown in FIG. 1a, the ink solution 36 exits the opening 38 and is discharged into the plurality of tubes 24. The number of tubes 24 is shown as exactly 4 tubes. It is contemplated that the number of tubes may vary from that depicted in the ink-replenishing system 10 of FIG. 1a. For example, the number of tubes may be as low as 1 and may include at least 10 tubes. Generally, the number of tubes selected will be based on the width of the printed area and the degree of localization of the new ink (i.e., the ability of the new ink to integrate with the old ink). It is desirable for the ink solution 36 to initially cover the screen 12 in a more generally uniform distribution. By having a more generally uniform distribution of the ink solution 36 on the screen 12, it reduces the likelihood that a sufficient amount of ink solution is placed on the screen at all desired locations.

The tubes 24 are desirably made from any material that will not react with the ink solution 36. Some non-limiting examples of materials that may form the tubes are stainless steel and polymeric materials. Some non-limiting examples of polymeric materials include polyethylenes (e.g., high density polyethylene (HDPE) and polytetrafluoroethylene (PTFE)). One commercial example of a polymeric material is TYGON® tubing. The tubes may be of different shapes and sizes as along as the ink solution 36 can be adequately supplied to the screen 12. It is contemplated that other discharge points for the ink solution beside a tube(s) may be used.

The pump 28 assists in controlling the rate (amount and frequency) of the ink solution 36 that is transported to the screen 12. One example of a pump that may be used is a peristaltic pump. Other positive displacement pumps may be used to assist in transporting the ink solution 36 to the screen 12. It is desirable for the wetted parts of the pump 28 to not adversely react with the ink solution 36.

The ink solution 36 is supplied onto the screen 12 using, for example, a moving tube holder 44. The ink solution 36 may be supplied to the screen 12 using a fixed tube holder. It is desirable for the ink solution 36 to be supplied onto the screen 12 in a generally uniform distribution, which will typically involve a moving tube holder if a smaller number of tubes is being used. If a larger number of tubes is used, a moving tube holder or a fixed tube holder may be used to achieve a generally uniform distribution.

The ink solution is added to the screen 12 in semi-continuous intervals. Semi-continuous as defined herein includes the ink solution being added to every print cycle in which printing is occurring. It is desirable for the ink solution to be added every cycle. Semi-continuous as defined herein also includes the ink solution being added in other cycle intervals such as every other cycle. The semi-continuous intervals are generally less than about 10 cycles and typically less than about 5 or 3 cycles. A typically range of semi-continuous intervals is from 1 to about 5 cycles. The ink should be added at a rate similar to, if not the same, as the rate of ink consumption.

In one embodiment, the ink solution comprises a liquid and an appropriately selected enzyme. The liquid in one embodiment is aqueous. Non-limiting examples of aqueous liquids that may be used include water, saline solutions, and buffered solutions. The liquid in another embodiment may be non-aqueous. It is desirable that the selected liquid does not react much, if any, with the selected enzyme.

The enzyme is selected to react with the desired analyte(s) to be tested so as to assist in determining an analyte concentration of a fluid sample. An enzyme that may be used to react with glucose is glucose oxidase. It is contemplated that other enzymes may be used to react with glucose such as glucose dehydrogenase. If the concentration of another analyte is to be determined, an appropriate enzyme is selected to reach with the analyte.

The ink solution in another embodiment further includes a mediator that is an electron acceptor and assists in generating a current that corresponds to the analyte concentration. If the enzyme is glucose oxidase, then a mediator (e.g., potassium ferricyanide) will be added to the ink solution.

In addition to the liquid and the active ingredients, the ink solution may include other ingredients. For example, the ink solution may include polymeric resins, rheological additives and fillers. It is contemplated that other types of components may be included in the ink solution.

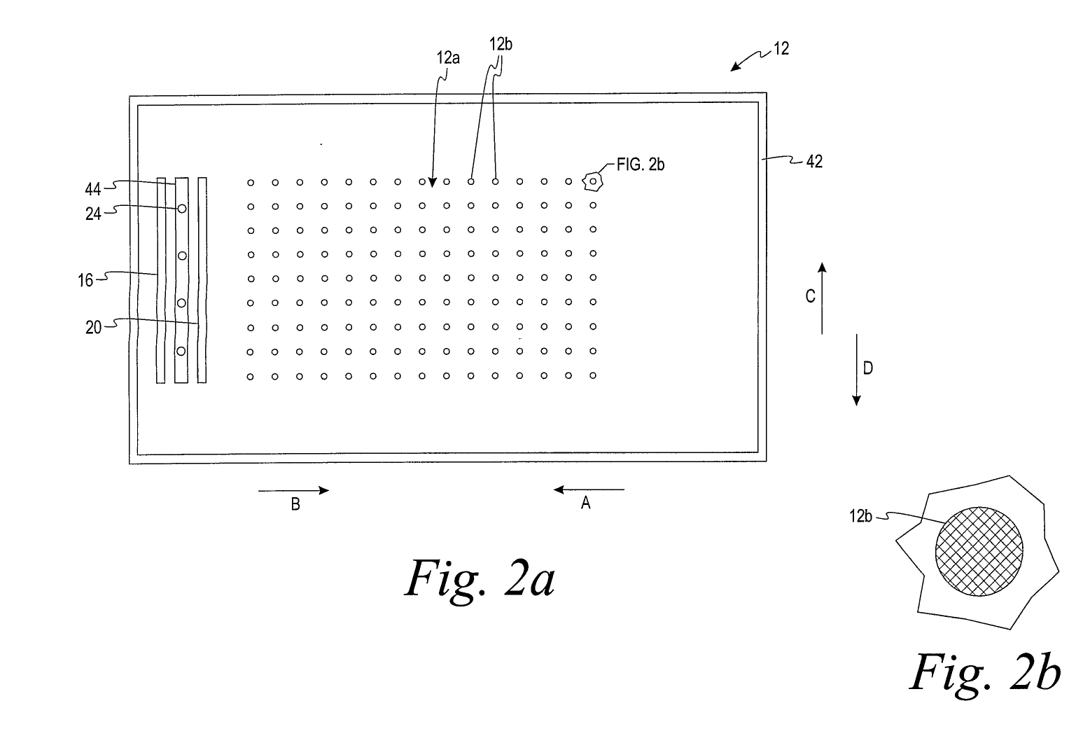

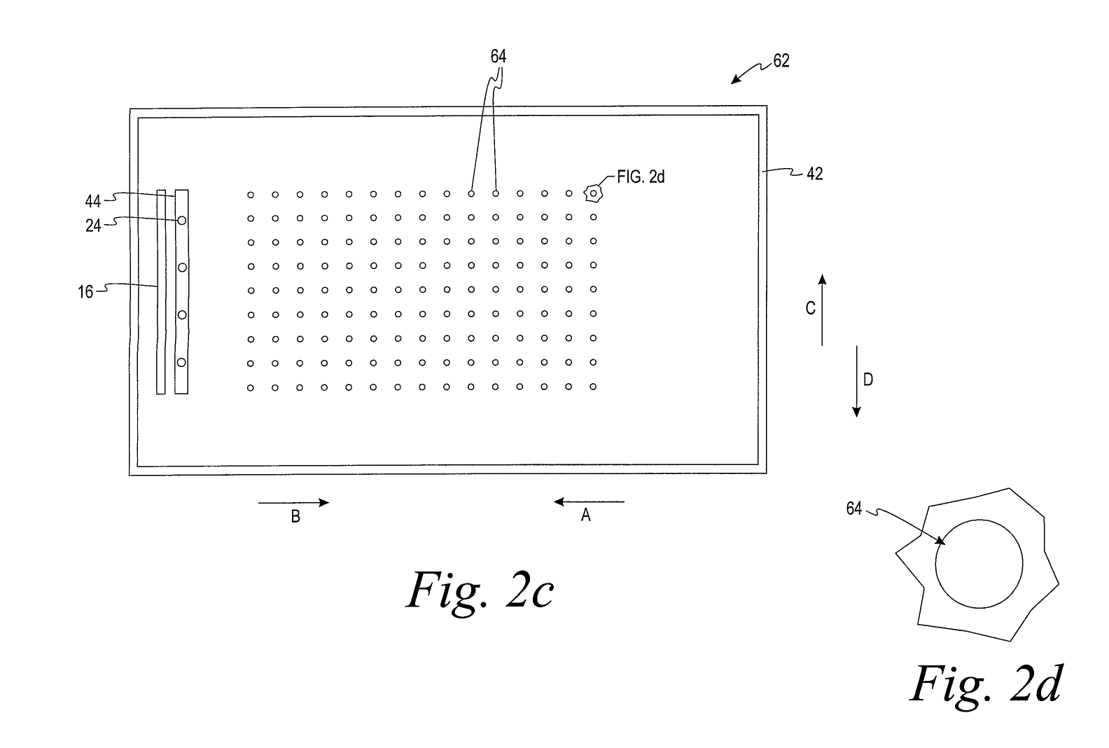

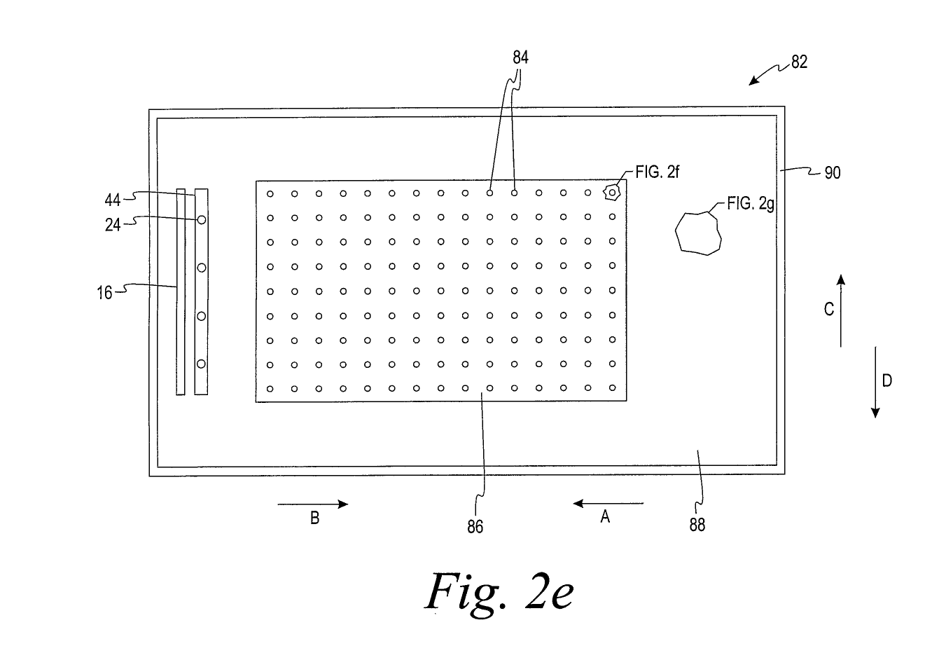

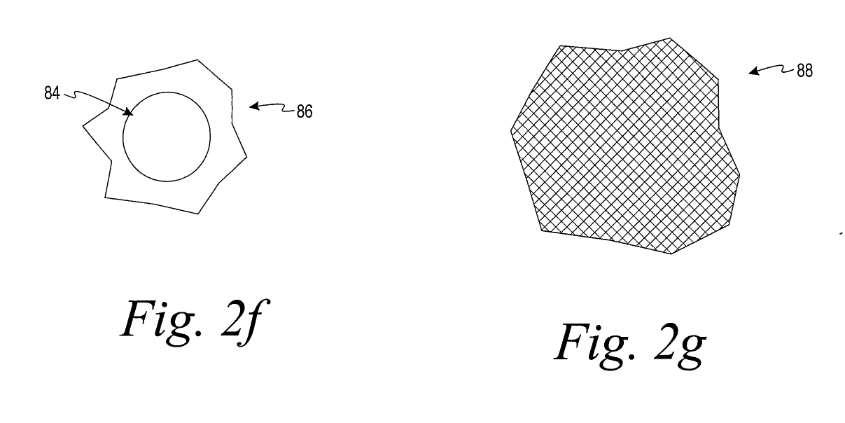

Referring to FIG. 1b, a schematic for an ink-replenishing stencil-printing system is shown. Ink-replenishing system 60 of FIG. 1b includes a stencil 62, the squeegee 16, the plurality of tubes 24, the pump 28 and the ink-solution reservoir or vessel 32. The ink-replenishing system 60 functions in a similar manner as described above in with ink-replenishing system 10 of FIG. 1a. Specifically, the squeegee 16, tubes 24, pump 28, the ink-solution reservoir 32 and the ink solution 36 function in the same manner as described above in connection with the ink-replenishing system 10. The ink solution 36 may be supplied onto the stencil 62 using the above discussed moving tube holder 44 or a fixed tube holder. It is desirable for the ink solution 36 to initially cover the stencil 62 in a more generally uniform distribution. The ink solution 36 is added to the stencil 62 in semi-continuous intervals. One difference is that stencil-printing systems typically do not include a flood bar. Differences between the screen 12 in the ink-replenishing system 10 and the stencil 62 in the ink-replenishing system 60 will be discussed in connection with FIGS. 2a-g below.

In further embodiments, the ink-replenishing systems 10, 60 may be used to print an adhesive. In such embodiments, the adhesive solution is printed onto a substrate, in which the adhesive is later adapted to adhere to the substrate to a second surface.

Referring to FIGS. 2a, 2b, a top view of the screen 12 along with a portion of the ink-replenishment system 10 is shown. The ink solution 36 is discharged from the plurality of tubes 24 onto the screen 12. The ink-replenishment system 10 includes the flood bar 20 that is adapted to be used in the print-flood technique or the flood-print technique. The process of discharging the ink solution 24 in connection with FIG. 2a will be described in a print-flood or a flood-print technique. It is contemplated that an alternative print technique or a print-print technique may be used with the system 10 shown in FIG. 2a, but would likely not use a flood bar.

Depending on the technique and the screen printer used, the ink may be spread in a variety of directions, such as in the directions of arrows A-D of FIG. 2a. One method of screen printing spreads the ink solution along the direction of arrow A and then uses a squeegee to force or push through the ink solution in the direction of arrow B. It is contemplated that the reverse directions may be used such as spreading the ink solution along the direction of arrow B and then using a squeegee in the direction of arrow A. Such techniques may also be used in spreading the ink solution along the directions of arrows C and D.

In one print-flood technique or a flood-print technique, the flood bar 20 typically moves in the direction of arrow A and spreads the ink solution 36 onto the remainder of the screen 12. The flood bar 20 moves from one end to the other end. The screen 12 includes a first portion 12a that includes an emulsion and a second portion 12b that is formed into the absence of an emulsion (also referred to as open areas of emulsion). One non-limiting example of an emulsion is a photosensitive emulsion. The second portion 12b is shown in FIGS. 2a,2b as a plurality of generally circular shapes, which is arranged in a pattern. It is contemplated that other shapes or patterns may be used other than that shown in FIGS. 2a,2b to form a second portion.

After the ink solution is spread on the screen 12, the squeegee 16 typically moves from one end to the other end in the direction of arrow B. As the squeegee 16 is moved in the direction of arrow B, the ink solution 36 is forced or pushed through the second portion 12b and onto a substrate 50 that is located beneath of the screen 12. The formed image on the substrate 50 (see FIG. 1a) corresponds to the second portion 12b, which does not include the emulsion. The squeegee 16 may be made of different materials such as rubber or metal. One typical rubber material that may be used in forming the squeegee 16 is polyurethane.

The screen 12 may be initially spaced apart from the substrate 50 and screen printing in this manner is referred to as off-contact printing. In this type of printing, the squeegee 16 forces the screen 12 in a downwardly direction into the substrate 50. Another form of printing is where the screen and substrate are brought into contact with each other and then the squeegee travels across the screen. After this print cycle is completed, the screen is raised to allow the substrate to cycle out from under the screen. This is referred to as contact printing.

One example of a material for forming the screen is a woven-mesh fabric. Other examples of materials that may be used in forming the screen material are stainless steel, polymeric materials (e.g., polyester) and a wire mesh. It is contemplated that other materials may be used in forming the screen. Screens are commercially available and may be obtained from a variety of companies including Sefar America, Inc. of Richfield, Minn. and Riv, Inc. of Merrimack, N.H.

Referring to FIGS. 2c, 2d, a top view of the stencil 62 along with a portion of the ink-replenishment system 60 is shown. The ink solution 36 is discharged from the plurality of tubes 24 onto the stencil 82.

Depending on the technique and the screen printer used, the ink may be spread in a variety of directions, such as in the directions of arrows A-D of FIG. 2c. One method of stencil printing spreads the ink solution along the direction of arrow A and then uses a squeegee to force or push through the ink solution in the direction of arrow B. It is contemplated that the reverse directions may be used such as spreading the ink solution along the direction of arrow B and then using a squeegee in the direction of arrow A. Such techniques may also be used in spreading the ink solution along the directions of arrows C and D.

The stencil 62 of FIGS. 2c, 2d forms a plurality of apertures 64 therein. The plurality of apertures 64 may be formed by cutting such as a laser cut or chemical etch. The plurality of apertures 64 is of a generally circular shape, which is arranged in a pattern. It is contemplated that other shapes or patterns may be used other than that shown in FIGS. 2c,2d to form the plurality of apertures.

After the ink solution is spread on the stencil 62, the squeegee 16 typically moves from one end to the other end in the direction of arrow B. As the squeegee 16 is moved in the direction of arrow B, the ink solution 36 is forced or pushed through the plurality of apertures 64 and onto a substrate 50 that is located beneath the stencil 62. The formed image on the substrate 50 corresponds to the plurality of apertures 64.

One type of printing is where the stencil and substrate are brought into contact with each other and then the squeegee travels across the stencil. After this print cycle is completed, the stencil is raised to allow the substrate to cycle out from under the screen. This is referred to as contact printing. The stencil may be initially spaced apart from the substrate and stencil printing in this manner is referred to as off-contact printing. In this type of printing, the squeegee 16 forces the stencil 62 in a downwardly direction into the substrate 50.

One example of a material for forming the stencil 62 is a metallic material such as stainless steel. It is contemplated that other metallic materials may be used in forming the stencil. Other examples of materials that may be used in forming the stencil include, but are not limited to, polymeric materials such as polyimides. It is contemplated that other materials may be used in forming the stencil. Stencils are commercially available and may be obtained from a variety of companies including Sefar America, Inc. of Richfield, Minn. and Riv, Inc. of Merrimack, N.H.

In another embodiment, the stencil may be a combination of materials. Referring to FIGS. 2e, 2f, 2g, a top view of a stencil 82 along with a portion of the ink-replenishment system 60 is shown. The stencil 82 forms a plurality of apertures 84, which is similar to the plurality of apertures 64 discussed above. The stencil 82 includes a first portion 86 and a second portion 88 that are attached to each other. The first portion 86 is a solid material such as a metallic material or a polymeric material. The second portion 88 is a screen or mesh that is attached to a frame 90. A generally center section of the second portion 88 is cut-away in the area generally corresponding to the first portion 86. As shown in FIG. 2e, the second portion 88 does not extend into an area of the first portion 86 where the plurality of apertures 84 is formed. In this embodiment, the second portion 88 provides flexibility to the stencil 82.

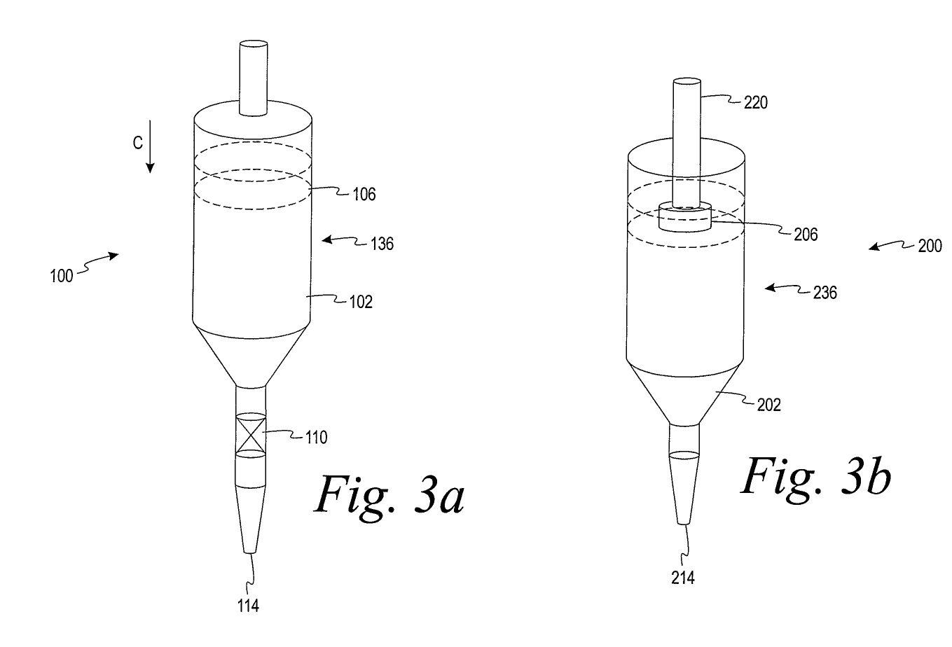

It is contemplated that the ink-solution vessel 32 of FIGS. 1a, 1b may be replaced by other ink-reservoir systems. For example, referring to FIG. 3a, an ink-reservoir system 100 is depicted. The ink-reservoir system 100 includes an ink reservoir 102 that contains ink solution 136, a plunger 106, and a flow- or time-control valve 110. The ink-reservoir system 100 is a generally constant, pressurized system. The ink solution 136 is the same as described above in connection with ink solution 36.

According to one embodiment, the ink-reservoir system 100 maintains a constant pressure generally of from 0 to about 100 psi. In operation, the ink reservoir system 100 is sufficiently pressurized such that when the flow-control valve 110 moves from a closed position to an open position, a known amount of ink solution 136 is discharged via opening 114 of the ink reservoir 102. When the flow control valve 110 moves to the open position, the pressure causes the plunger 106 to move in a downwardly direction (direction of arrow C in FIG. 3a) resulting in the ink solution 136 being discharged from the opening 114.

In another embodiment, the ink-reservoir system 200 of FIG. 3b includes an ink reservoir 202, a plunger 206, and a controlled displacement rod 220. The ink reservoir 202 contains an ink solution 236, which is the same as the ink solution 36 discussed above. The plunger 206 is connected to the controlled displacement rod 220 and assists in displacing the ink solution 236 from the ink reservoir 202. The controlled displacement rod 220 is moved a known distance, resulting in a known amount of ink solution 236 being displaced from the ink reservoir 202 via opening 214. The controlled displacement rod 214 may be moved by, for example, a twisting motion. It is contemplated that the displacement rod may be moved by other motions. Both the ink reservoir systems 100, 200 may be referred to as cartridge or syringe-type systems.

### Alternative Process A

A method of screen printing on a substrate, the method comprising the acts of:
providing a screen including a first portion with an emulsion and a second portion formed without an emulsion;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from an ink-solution reservoir.

### Alternative Process B

The method of alternative process A wherein the screen is a woven fabric.

### Alternative Process C

The method of alternative process A wherein the ink solution further comprises a mediator.

### Alternative Process D

The method of alternative process A wherein the enzyme is glucose oxidase and the ink solution further comprises a mediator.

### Alternative Process E

The method of alternative process A wherein the liquid is non-aqueous.

### Alternative Process F

The method of alternative process A wherein the liquid is aqueous.

### Alternative Process G

The method of alternative process A wherein each of the semi-continuous intervals is less than 10 cycles.

### Alternative Process H

The method of alternative process G wherein each of the semi-continuous intervals is less than 5 cycles.

### Alternative Process I

The method of alternative process H wherein the semi-continuous intervals is every cycle.

### Alternative Process J

The method of alternative process A wherein the ink solution is mechanically replenished using a positive displacement pump.

### Alternative Process K

The method of alternative process A wherein the ink solution reservoir is pressurized.

### Alternative Process L

The method of alternative process A wherein the ink solution reservoir is a pressurized cartridge.

### Alternative Process M

The method of alternative process A wherein the contacting of the ink solution onto the substrate via the second portion of the screen includes pushing the ink solution onto the substrate via a squeegee.

### Alternative Process N

The method of alternative process A wherein the replenishing ink is discharged from a plurality of discharge points.

### Alternative Process O

The method of alternative process N wherein the plurality of discharge points is tubes.

### Alternative Process P

The method of alternative process A wherein the emulsion is a photosensitive emulsion.

### Alternative Process Q

The method of alternative process A wherein the ink solution forms a spacer.

### Alternative Process R

A method of screen printing on a substrate, the method comprising the acts of:
providing a screen including a first portion with an emulsion and a second portion formed without an emulsion;
providing an ink-reservoir system including a plunger, a control valve and an ink-solution reservoir, the ink-reservoir system maintaining a generally constant pressure;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from the ink-solution reservoir.

### Alternative Process S

The method of alternative process R wherein the control valve is a flow-control valve or a time-control valve.

### Alternative Process T

The method of alternative process R wherein the pressure is from 0 to about 100 psi.

### Alternative Process U

A method of screen printing on a substrate, the method comprising the acts of:
providing a screen including a first portion with an emulsion and a second portion formed without an emulsion;
providing an ink-reservoir system including a plunger, a controlled displacement mechanism adapted to move a known distance, and an ink-solution reservoir, the movement of the controlled displacement mechanism resulting in a known amount of ink solution being displaced from the ink-reservoir system;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from the ink-solution reservoir.

### Alternative Process V

A method of stencil printing on a substrate, the method comprising the acts of:
providing a stencil;
supplying an ink solution on the stencil, the ink solution comprising a solid and a liquid, the ink solution including an enzyme to assist in determining an analyte concentration of a fluid sample;
contacting the ink solution onto the substrate; and
mechanically replenishing the ink solution in semi-continuous intervals from an ink-solution reservoir.

### Alternative Process W

The method of alternative process V wherein the stencil comprises metallic material, polymeric material or a combination thereof.

### Alternative Process X

The method of alternative process V wherein the stencil comprises a polymeric material, the polymeric material including a polyimide.

### Alternative Process Y

The method of alternative process V wherein the stencil comprises a metallic material, the metallic material including stainless steel.

### Alternative Process Z

The method of alternative process V wherein the stencil comprises a metallic material and a polymeric material.

### Alternative Process AA

The method of alternative process V wherein the ink solution further comprises a mediator.

### Alternative Process BB

The method of alternative process V wherein the enzyme is glucose oxidase and the ink solution further comprises a mediator.

### Alternative Process CC

The method of alternative process V wherein the liquid is non-aqueous.

### Alternative Process DD

The method of alternative process V wherein the liquid is aqueous.

### Alternative Process EE

The method of alternative process V wherein each of the semi-continuous intervals is less than 10 cycles.

### Alternative Process FF

The method of alternative process V wherein each of the semi-continuous intervals is less than 5 cycles.

### Alternative Process GG

The method of alternative process V wherein the semi-continuous intervals is every cycle.

### Alternative Process HH

The method of alternative process V wherein the ink solution is mechanically replenished using a positive displacement pump.

### Alternative Process II

The method of alternative process V wherein the ink solution reservoir is pressurized.

### Alternative Process JJ

The method of alternative process V wherein the ink solution reservoir is a pressurized cartridge.

### Alternative Process KK

The method of alternative process V wherein the contacting of the ink solution onto the substrate via the second portion of the screen includes pushing the ink solution onto the substrate via a squeegee.

### Alternative Process LL

The method of alternative process V wherein the replenishing ink is discharged from a plurality of discharge points.

### Alternative Process MM

The method of alternative process LL wherein the plurality of discharge points is tubes.

### Alternative Process NN

The method of alternative process V wherein the emulsion is a photosensitive emulsion.

### Alternative Process OO

The method of alternative process V wherein the ink solution forms a spacer.

### Alternative Process PP

A method of stencil printing on a substrate, the method comprising the acts of:
providing a stencil;
providing an ink-reservoir system including a plunger and a control valve, the ink-reservoir system maintaining a generally constant pressure;
supplying an ink solution on the stencil from the ink-reservoir system, the ink solution comprising a solid and a liquid, the ink solution including an enzyme to assist in determining an analyte concentration of a fluid sample;
contacting the ink solution onto the substrate; and
mechanically replenishing the ink solution in semi-continuous intervals from an ink-solution reservoir.

### Alternative Process QQ

A method of stencil printing on a substrate, the method comprising the acts of:
providing a stencil;
providing an ink-reservoir system including a plunger and a controlled displacement mechanism adapted to move a known distance, the movement of the controlled displacement mechanism resulting in a known amount of ink solution being displaced from the ink-reservoir system;
supplying an ink solution on the stencil from the ink-reservoir system, the ink solution comprising a solid and a liquid, the ink solution including an enzyme to assist in determining an analyte concentration of a fluid sample;
contacting the ink solution onto the substrate; and
mechanically replenishing the ink solution in semi-continuous intervals from an ink-solution reservoir.

### Alternative Process RR

A method of screen printing on a substrate, the method comprising the acts of:
providing a screen that includes a first portion with an emulsion and a second portion formed without an emulsion;
supplying an adhesive solution on the screen, the adhesive solution comprising a solid and a liquid, the adhesive solution being adapted to bind the substrate to a second surface;
contacting the adhesive solution onto the substrate via the second portion of the screen; and
mechanically replenishing the adhesive solution in semi-continuous intervals from an adhesive-solution reservoir.

### Alternative Process SS

A method of stencil printing on a substrate, the method comprising the acts of:
providing a stencil;
supplying an adhesive solution on the stencil, the adhesive solution comprising a solid and a liquid, the adhesive solution being adapted to bind the substrate to a second surface;
contacting the adhesive solution onto the substrate; and
mechanically replenishing the adhesive solution in semi-continuous intervals from an adhesive-solution reservoir.

While the present invention has been described with reference to one or more particular embodiments, those skilled in the art will recognize that many changes may be made thereto without departing from the spirit and scope of the present invention. Each of these embodiments, and obvious variations thereof, is contemplated as falling within the spirit and scope of the invention as defined by the appended claims.

1. A method of screen printing on a substrate, the method comprising the acts of:
providing a screen including a first portion with an emulsion and a second portion formed without an emulsion;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from an ink-solution reservoir.

2. The method of claim 1, wherein the screen is a woven fabric.

3. (canceled)

4. The method of claim 1, wherein the enzyme is glucose oxidase and the ink solution further comprises a mediator.

5. (canceled)

6. (canceled)

7. The method of claim 1, wherein each of the semi-continuous intervals is less than 10 cycles.

8. The method of claim 7, wherein each of the semi-continuous intervals is less than 5 cycles.

9. (canceled)

10. (canceled)

11. The method of claim 1, wherein the ink solution reservoir is pressurized.

12. (canceled)

13. The method of claim 1, wherein the contacting of the ink solution onto the substrate via the second portion of the screen includes pushing the ink solution onto the substrate via a squeegee.

14. The method of claim 1, wherein the replenishing ink is discharged from a plurality of discharge points.

15. (canceled)

16. The method of claim 1, wherein the emulsion is a photosensitive emulsion.

17. (canceled)

18. A method of screen printing on a substrate, the method comprising the acts of:
providing a screen including a first portion with an emulsion and a second portion formed without an emulsion;
providing an ink-reservoir system including a plunger, a control valve and an ink-solution reservoir, the ink-reservoir system maintaining a generally constant pressure;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from the ink-solution reservoir.

19. (canceled)

20. (canceled)

21. A method of screen printing on a substrate, the method comprising the acts of:
providing a screen including a first portion with an emulsion and a second portion formed without an emulsion;
providing an ink-reservoir system including a plunger, a controlled displacement mechanism adapted to move a known distance, and an ink-solution reservoir, the movement of the controlled displacement mechanism resulting in a known amount of ink solution being displaced from the ink-reservoir system;
supplying an ink solution on the screen, the ink solution comprising a solid and a liquid, the ink solution including an enzyme to assist in determining an analyte concentration of a fluid sample;
contacting the ink solution onto the substrate via the second portion of the screen; and
mechanically replenishing the ink solution in semi-continuous intervals from the ink-solution reservoir.

22. A method of stencil printing on a substrate, the method comprising the acts of:
providing a stencil;
supplying an ink solution on the stencil, the ink solution comprising a solid and a liquid, the ink solution including an enzyme to assist in determining an analyte concentration of a fluid sample;
contacting the ink solution onto the substrate; and
mechanically replenishing the ink solution in semi-continuous intervals from an ink-solution reservoir.

23. The method of claim 22, wherein the stencil comprises metallic material, polymeric material or a combination thereof.

24. The method of claim 22, wherein the stencil comprises a polymeric material, the polymeric material including a polyimide.

25. The method of claim 22, wherein the stencil comprises a metallic material, the metallic material including stainless steel.

26. The method of claim 22, wherein the stencil comprises a metallic material and a polymeric material.

27. The method of claim 22, wherein the ink solution further comprises a mediator.

28. The method of claim 22, wherein the enzyme is glucose oxidase and the ink solution further comprises a mediator.

29. (canceled)

30. (canceled)

31. The method of claim 22, wherein each of the semi-continuous intervals is less than 10 cycles.

32. (canceled)

33. (canceled)

34. (canceled)

35. (canceled)

36. The method of claim 22, wherein the ink solution reservoir is a pressurized cartridge.

37. (canceled)

38. (canceled)

39. (canceled)

40. (canceled)

41. (canceled)

42. (canceled)

43. (canceled)

44. (canceled)

45. (canceled)
